(19) United States
(12) Patent Application Publication
(10) Pub. No.: US 2017/0347686 A1
(43) Pub. Date: Dec. 7, 2017

(54) DRIED SUPPLEMENT PRODUCT

(71) Applicant: Nancy Lee Pohlman, CAMP VERDE, AZ (US)

(72) Inventor: Nancy Lee Pohlman, CAMP VERDE, AZ (US)

(21) Appl. No.: 15/170,761

(22) Filed: Jun. 1, 2016

(51) Int. Cl. A23K 50/20; A23K 20/22; A23K 20/158; A23K 20/174; A23K 20/121; A23K 10/30

(52) U.S. Cl. CPC A23K 50/20; A23K 20/121; A23K 10/30; A23K 20/158; A23K 20/174; A23K 20/22

(57) ABSTRACT

Some embodiments of the present disclosure include a dried product for providing a supplement to a horse. The dried product may include a mixture of a horse supplement, beet pulp, water, horse feed, a safflower oil/vitamin E oil mixture, ground alfalfa, white flour, sea salt, fenugreek, ascorbic acid, and fruit pectin or apple pectin, wherein the product is in the form of a compressed product, such as a compressed round disk. For example, in an embodiment, the compressed round disk may have a diameter of about 2.5 inches and a thickness of about 1 inch.

### BACKGROUND

The embodiments herein relate generally to animals, and more particularly, to a dried product, such as a dried disk, for delivering a supplement to an animal, such as a horse, donkey, mule, or the like.

Conventionally, supplements are delivered to animals, such as horses, by simply mixing the supplement in with the horse's feed. However, having to premix grains with supplements is inconvenient and time consuming.

Therefore, what is needed is a dried product for delivering a supplement to a horse without having to premix any ingredients.

### SUMMARY

Some embodiments of the present disclosure include a dried product for providing a supplement to an animal, such as a horse. The dried product may include a mixture of a horse supplement, beet pulp, water, horse feed , a safflower oil/vitamin E oil mixture, ground alfalfa, white flour, sea salt, fenugreek, ascorbic acid, and fruit pectin or apple pectin, wherein the product is in the form of a compressed product, such as a compressed round disk. For example, in an embodiment, the compressed round disk may have a diameter of about 2.5 inches and a thickness of about 1 inch.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used to deliver a supplement to an animal, such as a horse and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

1. Dried Product

The various elements of the device of the present disclosure may be related in the following exemplary fashion. It is not intended to limit the scope or nature of the relationships between the various elements and the following examples are presented as illustrative examples only.

By way of example, some embodiments of the present disclosure include a dried product for providing a supplement to an animal, such as a horse, the dried product comprising a mixture of a horse supplement, beet pulp, water, horse feed, a safflower oil/vitamin E oil mixture, ground alfalfa, white flour, sea salt, fenugreek, ascorbic acid, and fruit pectin or apple pectin, wherein the product is in the form of a compressed product, such as a compressed round disk. For example, in some embodiments, the compressed round disk may have a diameter of about 2.5 inches and a thickness of about 1 inch. However, other shapes and sizes are certainly envisioned.

The dried product may comprise any kind of equine supplement in pellet or powder form. For example, some embodiments of the dried disk may include psyllium(which treats sand colic); biotin (which improves the health of hoofs, coat, and skin); a joint supplement, such as hyaluronic acid, glucosamine, chondroline, chondroitin, methylsulfonyl-methane (MSM), yucca, or collagen; vitamins; probiotics (which may improve digestion and/or help with diarrhea); electrolytes (which may help with water intake); calming products; a fly killer; a respiratory supplement; a performance supplement; a senior supplement; a blood builder; a combination thereof; or the like.

In embodiments, the dried product may further comprise a flavoring, such as fenugreek (maple), peppermint, banana, cherry, mint, or any other desired flavor.

An example of how to make a batch of dried products may include the following. About 4 cups of ground beet pulp may be mixed with about 4 cups of water and allowed to sit for about 5 minutes. Separately, about 8 cups of horse feed may be mixed with about 4 cups of water. About 3/4 cup of a safflower oil/vitamin E oil mixture may be added to the wet horse feed, which may be allowed to sit for about 5 minutes. In embodiments, the safflower oil/vitamin E oil mixture may comprise about 6 part of safflower oil to about 1 part of vitamin E oil. Simultaneously the following dry ingredients may be mixed: a desired to necessary amount of the equine supplement, about 25 cups ground alfalfa, about 6 cups white flour, about 1 cup sea salt, about 1 1/2 cups powdered fenugreek, about 3/4 cups powdered ascorbic acid, and about 3/4 cups fruit pectin or apple pectin. The dry ingredients may be thoroughly blended and then the wet beet pulp and the wet horse feed may be added to the dry ingredients, which may then be mixed well. About 40 oz. of water may be added to the batch a little at a time, such as by supplying a slow steady stream of water or spray water to the batch while it is being mixed, creating the product. The product may then be formed into the desired shape, such as a disk, and then dehydrated, vacuumed, heated, or the like to remove the moisture from the compressed disk.

To use the dried product of the present disclosure, a user may simply hand feed the product to a horse. Alternatively, the product may be thrown into a bucket that the horse eats from. Thus, the product may remove the need for a caretaker to separately add supplements to a horse's food.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A dried product for providing a supplement to a horse, the dried product comprising:
a horse supplement;
beet pulp;
water;
horse feed;
a safflower oil/vitamin E oil mixture;
alfalfa;
white flour;
sea salt;
fenugreek;
ascorbic acid; and
a member selected from the group consisting of fruit pectin and apple pectin,
wherein:
the dried product is in the form of a compressed product.

2. The dried product of claim 1, wherein the dried product is a compressed round disk.

3. The dried product of claim 2, wherein the compressed round disk has a diameter of about 2.5 inches and a thickness of about 1 inch.

4. The dried product of claim 1, wherein the horse supplement is at least one member selected from the group consisting of psyllium, biotin, a joint supplement, vitamins, probiotics, electrolytes, calming products, a fly killer, a respiratory supplement, a performance supplement, a senior supplement, a blood builder, and a combination thereof

5. The dried product of claim 1, comprising:
a mixture of about 4 cups ground beet pulp and about 4 cups water;
a mixture of about 8 cups horse feed, about 4 cups water, and about ¾ cup of the safflower oil/vitamin E oil mixture;
a mixture comprising:
about 25 cups ground alfalfa;
about 6 cups white flour;
about 1 cup sea salt;
about 1 1/2 cups powdered fenugreek;
about ¾ cups powdered ascorbic acid;
about ¾ cups of fruit pectin; and
a desired amount of the horse supplement.

6. The dried product of claim 1, wherein the safflower oil/vitamin E oil mixture comprises about 6 parts safflower oil to about 1 part vitamin E oil.
